(19) United States
(12) Patent Application Publication
(10) Pub. No.: US 2016/0099859 A1
(43) Pub. Date: Apr. 7, 2016

(54) Reverse Path Validation for Source Routed Networks

(71) Applicant: Futurewei Technologies, Inc., Plano, TX (US)

(72) Inventors: Mehdi Arashmid Akhavain Mohammadi, Ottawa (CA); Peter Ashwood-Smith, Gatineau (CA); Tao Wan, Ottawa (CA)

(21) Appl. No.: 14/507,142

(22) Filed: Oct. 6, 2014

(51) Int. Cl. H04L 12/26; H04L 12/741; H04L 12/721

(52) U.S. Cl. CPC H04L 43/50; H04L 45/36; H04L 45/566; H04L 45/12; H04L 45/74

(57) ABSTRACT

A packet forwarding validation method comprising receiving a data packet that comprises a next-hop index and a plurality of next-hop identifiers, wherein the next-hop index references a next-hop identifier from the plurality of next-hop identifiers, and wherein the plurality of next-hop identifiers indicates a sequence of next-hops through a network for the data packet, identifying a previous-hop network node using the next-hop index and the plurality of next-hop identifiers, determining a transmitter network node of the data packet, comparing the previous-hop network node and the transmitter network node, detecting a forwarding error when the previous-hop network node and the transmitter network node are not the same, and processing the data packet when the previous-hop network node and the transmitter network node are the same.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In index based source routed networks, a data packet may carry both a payload (e.g., data content) and path information for routing the data packet. In many implementations it is desirable to be able to ensure that the data packet is correctly routed through a network along the intended next-hop nodes and/or links. Conventional validation techniques, such as, reverse path forwarding checking, resource reservation protocol (RSVP) record routing, multiprotocol label switch (MPLS) pinging, and trace routing may use source addresses and/or destination addresses with a look-up table to route data packets through a network, but may not be able to detect routing errors. As such, conventional validation techniques may not be suitable for index based source routed networks. When a data packet is incorrectly transmitted through a network, the data packet may be discarded and/or misrouted. A mechanism to enable a receiver to validate the forwarding of data packets through an index based source routed network may be desirable.

### SUMMARY

In one embodiment, the disclosure includes a packet forwarding validation method comprising receiving a data packet that comprises a next-hop index and a plurality of next-hop identifiers, wherein the next-hop index references a next-hop identifier from the plurality of next-hop identifiers, and wherein the plurality of next-hop identifiers indicates a sequence of next-hops through a network for the data packet, identifying a previous-hop network node using the next-hop index and the plurality of next-hop identifiers, determining a transmitter network node of the data packet, comparing the previous-hop network node and the transmitter network node,

detecting a forwarding error when the previous-hop network node and the transmitter network node are not the same, and processing the data packet when the previous-hop network node and the transmitter network node are the same.

In another embodiment, the disclosure includes an apparatus comprising a receiver configured to receive a data packet that comprises a next-hop index, wherein the next-hop index indicates a next-hop entry from a plurality of next-hop identifiers, the plurality of next-hop identifiers, wherein the plurality of next-hop identifiers identifies a sequence of next-hop network nodes for the data packet, and a payload, and a processor coupled to a memory and the receiver, wherein the memory comprises computer executable instructions stored in a non-transitory computer readable medium such that when executed by the processor causes the processor to identify a previous-hop network node using the next-hop index, determine a transmitter network node for the data packet, compare the previous-hop network node and the transmitter network node, indicate a forwarding error when the previous-hop network node and the transmitter network node do not match, and forward the data packet when the previous-hop network node and the transmitter network node match.

In yet another embodiment, the disclosure includes a computer program product comprising executable instructions stored on a non-transitory computer readable medium, such that, when executed by a processor, causes a network node to receive a data packet that comprises a next-hop index, wherein the next-hop index indicates a next-hop entry from a plurality of next-hop identifiers, the plurality of next-hop identifiers, wherein the plurality of next-hop identifiers identifies a sequence of next-hop network nodes for the data packet, and a payload, determine a previous-hop network node using the next-hop index, identify a transmitter network node for the data packet, compare the previous-hop network node and the transmitter network node, indicate a forwarding error when the previous-hop network node and the transmitter network node do not match, and forward the data packet when the previous-hop network node and the transmitter network node match.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a network.

FIG. 2 is a schematic diagram of an embodiment of a network element.

FIG. 3 is a schematic diagram of an embodiment of a source routed data packet.

FIG. 4 is a schematic diagram of an embodiment of a network communicating a source routed data packet.

FIG. 5 is schematic diagram of another embodiment of a network communicating a source routed data packet.

FIG. 6 is a flowchart of an embodiment of a packet forwarding validation method.

FIG. 7 is a flowchart of another embodiment of a packet forwarding validation method.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are various embodiments for validating packet forwarding through a source routed network and identifying a point of network failure. Various embodiments may allow a network operator to validate an actual data path against a data path determined by a controller, which may allow the network operator to identify a point of network failure when an error is detected. For example, path forwarding validation may provide a hop by hop data path validation and/or verification based on an incoming link and/or header information. Packet forwarding may be validated without substantial packet modifications and/or without separate debugging protocols. Additionally, packet forwarding validation may be implemented in conjunction with a network repair mechanism (e.g., source routing fast re-route) and may reduce traffic interruptions.

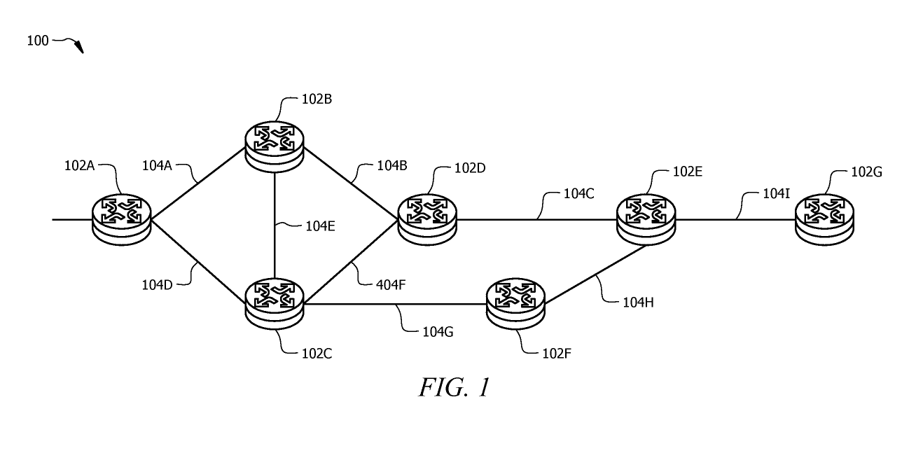

FIG. 1 is a schematic diagram of an embodiment of a network 100 where an embodiment of the present disclosure may operate. Network 100 may be configured as an index based source routed network and may comprise a plurality of network nodes 102A-102G. The network nodes 102A-102G may be any devices and/or components that support the transport of data traffic (e.g., data packets) through the network 100. For example, network nodes 102A-102G may comprise switches, routers, any other suitable network device for communicating data packets as would be appreciated by one of ordinary skill in the art upon viewing this disclosure, or combinations thereof. Network nodes 102A-102G may be configured to receive a data packet from other network nodes, to validate a path routing, and to transmit the data packet to other network nodes. One or more network nodes 102A-102G may be configured by a network operator and/or a centralized controller (e.g., a software-defined network (SDN) controller). Network nodes 102A-102G may be coupled to one another via a plurality of links 104A-104I. Links 104A-104I discussed herein may be physical links, such as, electrical links, optical links, and/or logical links (e.g., virtual links) used to transport data. It will be appreciated by those skilled in the art that the links between network nodes can also be logical links (e.g., a link between two nodes may appear direct at a logical level but involve routing through other nodes at a physical level. While the embodiment of FIG. 1 is disclosed with respect to a particular configuration of network nodes 102A-102G, it is noted that the network 100 may comprise any suitable number of network nodes 102A-102G and/or configuration of network nodes 102A-102G as would be appreciated by one of ordinary skill in the art upon viewing this disclosure.

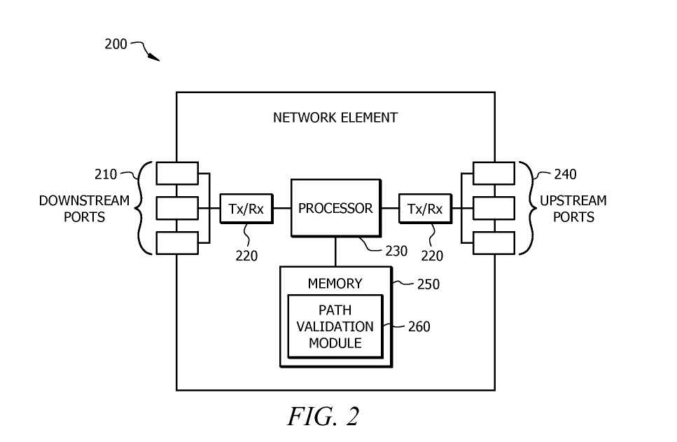

FIG. 2 is a schematic diagram of an embodiment of a network element 200 that may be used to transport and process data traffic through at least a portion of the network 100 shown in FIG. 1. For example, network element 200 may be a network node 102A-102G described in FIG. 1. At least some of the features/methods described in the disclosure may be implemented in the network element 200. For instance, the features/methods of the disclosure may be implemented in hardware, firmware, and/or software installed to run on the hardware. The network element 200 may be any device (e.g., a modem, a switch, router, bridge, server, client, etc.) that transports data through a network, system, and/or domain. Moreover, the terms network “element,” network “node,” network “component,” network “module,” and/or similar terms may be interchangeably used to generally describe a network device and do not have a particular or special meaning unless otherwise specifically stated and/or claimed within the disclosure. In one embodiment, the network element 200 may be an apparatus configured to communicate data packets and to validate packet forwarding through a network. For example, network element 200 may be implemented in and/or integrated within a network node 102A-102G described in FIG. 1.

The network element 200 may comprise one or more downstream ports 210 coupled to a transceiver (Tx/Rx) 220, which may be transmitters, receivers, or combinations thereof. The Tx/Rx 220 may transmit and/or receive frames from other network nodes via the downstream ports 210. Similarly, the network element 200 may comprise another Tx/Rx 220 coupled to a plurality of upstream ports 240, wherein the Tx/Rx 220 may transmit and/or receive frames from other nodes via the upstream ports 240. The downstream ports 210 and/or the upstream ports 240 may include electrical and/or optical transmitting and/or receiving components.

A processor 230 may be coupled to the Tx/Rx 220 and may be configured to process the frames and/or determine which nodes to send (e.g., transmit) the packets. In an embodiment, the processor 230 may comprise one or more multi-core processors and/or memory modules 250, which may function as data stores, buffers, etc. The processor 230 may be implemented as a general processor or may be part of one or more application specific integrated circuits (ASICs), field-programmable gate arrays (FPGAs), and/or digital signal processors (DSPs). Although illustrated as a single processor, the processor 230 is not so limited and may comprise multiple processors. The processor 230 may be configured to validate packet forwarding and/or to identify a point of failure in a network.

FIG. 2 illustrates that a memory module 250 may be coupled to the processor 230 and may be a non-transitory medium configured to store various types of data. Memory module 250 may comprise memory devices including secondary storage, read-only memory (ROM), and random-access memory (RAM). The secondary storage is typically comprised of one or more disk drives, optical drives, solid-state drives (SSDs), and/or tape drives and is used for non-volatile storage of data and as an over-flow storage device if the RAM is not large enough to hold all working data. The secondary storage may be used to store programs that are loaded into the RAM when such programs are selected for execution. The ROM is used to store instructions and perhaps data that are read during program execution. The ROM is a non-volatile memory device that typically has a small memory capacity relative to the larger memory capacity of the secondary storage. The RAM is used to store volatile data and perhaps to store instructions. Access to both the ROM and RAM is typically faster than to the secondary storage.

The memory module 250 may be used to house the instructions for carrying out the various example embodiments described herein. In one example embodiment, the memory module 250 may comprise a path validation module 260 that may be implemented on the processor 230. In one embodiment, the path validation module 260 may be implemented to communicate data packets through a network (e.g., an index based source routed network), to validate packet forwarding, and/or to identify a point of failure in the network. For example, the path validation module 260 may be configured to determine if a received data packet has been properly forwarded from a transmitter. Path validation module 260 may be implemented in a transmitter (Tx), a receiver (Rx), or both.

It is understood that by programming and/or loading executable instructions onto the network element 200, at least one of the processor 230, the cache, and the long-term storage are changed, transforming the network element 200 in part into a particular machine or apparatus, for example, a multi-core forwarding architecture having the novel functionality taught by the present disclosure. It is fundamental to the electrical engineering and software engineering arts that functionality that can be implemented by loading executable software into a computer can be converted to a hardware implementation by well-known design rules known in the art. Decisions between implementing a concept in software versus hardware typically hinge on considerations of stability of the design and number of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable will be produced in large volume may be preferred to be implemented in hardware (e.g., in an ASIC) because for large production runs the hardware implementation may be less expensive than software implementations. Often a design may be developed and tested in a software form and then later transformed, by well-known design rules known in the art, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Any processing of the present disclosure may be implemented by causing a processor (e.g., a general purpose processor which can optionally have multiple processing cores) to execute a computer program. In this case, a computer program product can be provided to a computer or a network device using any type of non-transitory computer readable media. The computer program product may be stored in a non-transitory computer readable medium in the computer or the network device. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), compact disc read-only memory (CD-ROM), compact disc recordable (CD-R), compact disc rewritable (CD-R/W), digital versatile disc (DVD), Blu-ray (registered trademark) disc (BD), and semiconductor memories (such as mask ROM, programmable ROM (PROM), erasable PROM), flash ROM, and RAM). The computer program product may also be provided to a computer or a network device using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

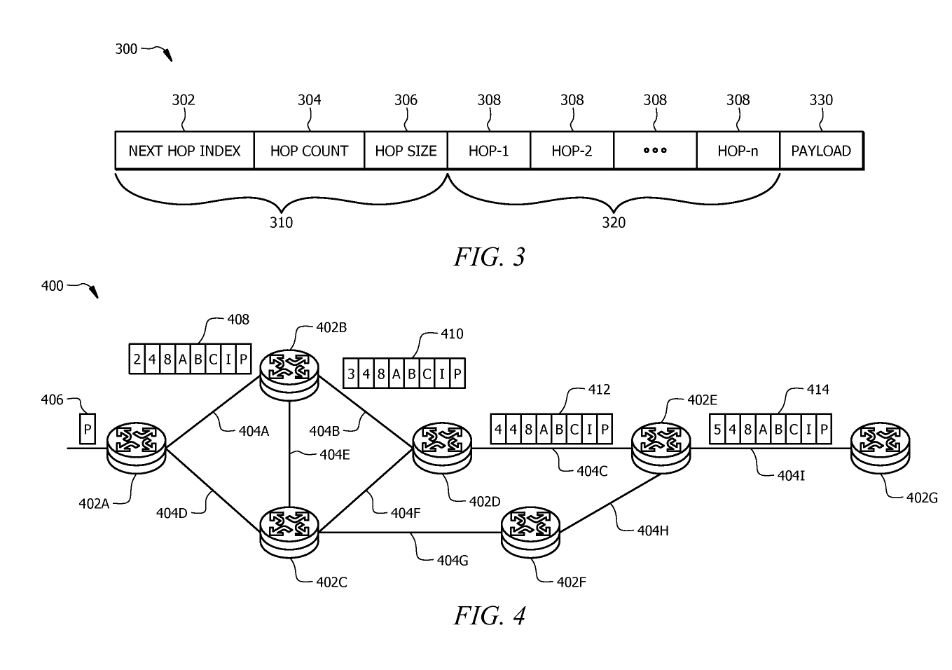

FIG. 3 is a schematic diagram of an embodiment of a source routed data packet 300. In an embodiment, the source routed data packet 300 may be used to forward data content through an index based source routed network. For example, a source routed data packet 300 may be communicated through the network 100 by the plurality of network nodes 102A-102G described in FIG. 1. The source routed data packet 300 may generally comprise a header portion 310, a path routing portion 320, and a payload portion 330. The header portion 310 may comprise information for routing a data packet through a network. The path routing portion 320 may identify a plurality of next-hops 308 (e.g., next-hop network nodes, links, ports, and/or interfaces) for a data packet to traverse along a path. The payload portion 330 may comprise a payload or data content.

In an embodiment, the header portion 310 comprises a next-hop index field 302, a hop count field 304, and a hop size field 306. The next-hop index field 302 may comprise a next-hop index value that identifies a next-hop entry in the path routing portion 320. The hop count field 304 may comprise a hop count value that indicates the number of hops from a source network node to a destination network node. The hop count field 304 may be used in conjunction with the next-hop index field 302 to determine whether a network node is the destination network node. The hop size field 306 may comprise a length value that indicates the length (e.g., in bits or bytes) of each entry in the path routing portion 320. In an embodiment, the next-hop index field 302 and the hop size field 306 may be used in conjunction to parse and/or to traverse through the entries of the path routing portion 320. For example, the product of the value of the next-hop index field 302 and the value of the hop size field 306 may produce an offset that may be used to determine (e.g., locate) an entry in the path routing portion 320.

FIG. 4 is a schematic diagram of an embodiment of a network 400 communicating a source routed data packet. Network 400 may comprise a plurality of network nodes 402A-402G and a plurality of links 404A-4041. The network nodes 402A-402G may be configured similar to network nodes 102A-102G and the links 404A-404I may be configured similar to links 104A-104I described in FIG. 1. Network 400 may be configured to communicate data traffic (e.g., data packets) in a flow direction from network node 402A to network node 402G. Network node 402A may be configured to obtain (e.g., to receive or to generate) a data packet 406, to generate a data packet 408, and to send data packet 408 according to the path routing portion of data packet 408. Data packet 408 may be a source routed data packet (e.g., source routed data packet 300 described in FIG. 3). Network node 402A may be configured to encapsulate and/or to add a plurality of fields (e.g., a path routing portion 320 described in FIG. 3) to data packet 406 to generate data packet 408. Data packet 408 may comprise a header portion that comprises a next-hop index field with a value of one, a hop count field with a value of four, and a hop size field with a value of eight. The path routing portion of data packet 408 may indicate a forwarding route along link 404A, link 404B, link 404C, and link 4041. The payload portion of data packet 408 may comprise the payload portion of data packet 406. Network node 402A may be configured to send data packet 408 according to the next-hop index value and the path routing portion of data packet 408. The next-hop index value may reference a first entry in the path routing portion which may indicate to send data packet 408 along link 404A to network node 402B. The next-hop index value may be incremented to a value of two and the data packet 408 may be sent to the next-hop.

Network node 402B may be configured to receive data packet 408, to validate the packet forwarding of data packet 408, to generate data packet 410, and to send data packet 410 according to the path routing portion of data packet 410. Network node 402B may be configured to examine the data packet 408 to validate the packet forwarding. Network node 402B may be configured to determine a previous-hop network node by decrementing the next-hop index field value of the data packet 408 and using the decremented next-hop index field value to locate an entry for the previous-hop network node in the path routing portion of data packet 408. For example, the next-hop index value of two may be decremented to obtain a decremented next-hop value of one. The value of one for the decremented next-hop index may reference the first entry in the path routing portion of the data packet 408 which may be used to identify a previous-hop network node also referred to as a transmitter network node. The entry in the path routing portion of the data packet 408 may reference a network node, a port, and/or a link. For example, the first entry in the path routing portion of the data packet 408 may indicate link 404A which may be associated with network node 402A as a previous-hop network node or a transmitter network node on link 404A. Network node 402B may be configured to compare the previous-hop network node indicated by the path routing portion of data packet 408 with the transmitter network node of the data packet 408 (e.g., an actual previous-hop network node). For example, network node 402B may determine the transmitter network node of the data packet 408 by examining an incoming interface (e.g., a link and/or port) where the data packet 408 was received and determining a transmitter associated or connected to the incoming interface. Network node 402B may be configured to discard the data packet 408 and/or to indicate an error has occurred when there is a mismatch between the previous-hop network node indicated by the path routing portion of data packet 408 and the transmitter network node of the data packet 408. When there is not a mismatch between the previous-hop network node indicated by the path routing portion of data packet 408 and the transmitter network node of the data packet 408, network node 402B may be configured to further process data packet 408. Network node 402B may be configured to compare the next-hop index value (e.g., the next-hop value of two) and the hop count value (e.g., the hop count value of four) of data packet 408 to determine if network node 402B is the destination node for the payload. When the next-hop index value is less than or about equal to the hop count value, network node 402B may be configured to determine that network node 402B is not the destination node for the payload. Network node 402B may be configured to send data packet 410 according to the original next-hop index value (e.g., the non-decremented next-hop index value of two) and the path routing portion of data packet 410. The next-hop index value may reference a second entry in the path routing portion which may indicate to send data packet 410 along link 404B to network node 402D. Prior to sending data packet 410, network node 402B may increment the next-hop index value of data packet 408 and may use the incremented next-hop field value (e.g., an incremented next-hop value of three) as the next-hop index value in data packet 410.

Network node 402D may be configured to receive data packet 410, to validate the packet forwarding of data packet 410, to generate data packet 412, and to send data packet 412 according to the path routing portion of data packet 412 similar to as previously described. Network node 402D may be configured to examine the data packet 410 to validate the packet forwarding. Network node 402D may be configured to determine a previous-hop network node by decrementing the next-hop index value of data packet 410 and using the decremented next-hop index value to locate an entry for the previous-hop network node in the path routing portion of data packet 410. Network node 402D may be configured to compare the previous-hop network node indicated by the path routing portion of data packet 410 with the transmitter network node of the data packet 410. Network node 402D may be configured to discard the data packet 410 and/or to indicate an error has occurred when there is a mismatch between the previous-hop network node indicated by the path routing portion of data packet 410 and the transmitter network node of the data packet 410. When there is not a mismatch between the previous-hop network node indicated by the path routing portion of data packet 410 and the transmitter network node of the data packet 410, network node 402D may be configured to further process data packet 410. Network node 402D may be configured to compare the next-hop index value and the hop count value of data packet 410 to determine if network node 402D is the destination node for the payload. When the next-hop index value is less than or about equal to the hop count field value, network node 402D may be configured to determine that network node 402D is not the destination node for the payload. Network node 402D may be configured to send data packet 412 according to the original next-hop index value and the path routing portion of data packet 410. The next-hop index value of data packet 410 may reference a third entry in the path routing portion which may indicate to send data packet 412 along link 404C to network node 402E. Prior to sending data packet 412, network node 402D may increment the next-hop index value of data packet 410 and may use the incremented next-hop value as the next-hop index value in data packet 412.

Network node 402E may be configured to receive data packet 412, to validate the packet forwarding of data packet 412, to generate data packet 414, and to send data packet 414 according to the path routing portion of data packet 414 similar to as previously described. Network node 402E may be configured to examine the data packet 412 to validate the packet forwarding. Network node 402E may be configured to determine a previous-hop network node by decrementing the next-hop index value of data packet 412 and using the decremented next-hop index value to locate an entry for the previous-hop network node in the path routing portion of data packet 412. Network node 402E may be configured to compare the previous-hop network node indicated by the path routing portion of data packet 412 with the transmitter network node of the data packet 412. Network node 402E may be configured to discard the data packet 412 and/or to indicate an error has occurred when there is a mismatch between the previous-hop network node indicated by the path routing portion of data packet 412 and the transmitter network node of the data packet 412. When there is not a mismatch between the previous-hop network node indicated by the path routing portion of data packet 412 and the transmitter network node of the data packet 412, network node 402E may be configured to further process data packet 412. Network node 402E may be configured to compare the next-hop index value and the hop count value of data packet 412 to determine if network node 402E is the destination node for the payload. When the next-hop index value is less than or about equal to the hop count value, network node 402E may be configured to determine that network node 402E is not the destination node for the payload. Network node 402E may be configured to send data packet 414 according to the original next-hop index value and the path routing portion of data packet 412. The next-hop index value of data packet 410 may reference a fourth entry in the path routing portion which may indicate to send data packet 414 along link 4041 to network node 402G. Prior to sending data packet 414, network node 402E may increment the next-hop index value of data packet 412 and may use the incremented next-hop value as the next-hop index value in data packet 414.

Network node 402G may be configured to receive data packet 414, to validate the packet forwarding of data packet 414, to unencapsulate data packet 414, and to process the payload. It is noted that terms “unencapsulate” and “decapsulation” may be used interchangeably as would be appreciated by one of ordinary skill in the art. Network node 402G may be configured to examine the data packet 414 to validate the packet forwarding. Network node 402G may be configured to determine a previous-hop network node by decrementing the next-hop index value of data packet 414 and using the decremented next-hop index value to locate an entry for the previous-hop network node in the path routing portion of data packet 414. Network node 402G may be configured to compare the previous-hop network node indicated by the path routing portion of data packet 414 with the transmitter network node of the data packet 414. Network node 402G may be configured to discard the data packet 414 and/or to indicate an error has occurred when there is a mismatch between the previous-hop network node indicated by the path routing portion of data packet 414 and the transmitter network node of the data packet 414. When there is not a mismatch between the previous-hop network node indicated by the path routing portion of data packet 414 and the transmitter network node of the data packet 414, network node 402G may be configured to further process data packet 414. Network node 402G may be configured to compare the next-hop index value and the hop count value of data packet 414 to determine if network node 402G is the destination node for the payload. When the next-hop index value is greater than the hop count value, network node 402G may be configured to determine that network node 402G is the destination node for the payload. Network node 402G may be configured to process data packet 414. Processing the data packet 414 may comprise unencapsulating and/or removing a plurality of fields (e.g., the path routing portion) from the data packet 414 and processing the payload. The payload portion of data packet 414 may be substantially similar to the payload portion of data packet 406. Processing the payload portion may comprise using the payload, storing the payload into a memory, forwarding the payload, routing (e.g., Internet Protocol (IP) routing) the payload, and/or any other suitable processes as would be appreciated by one of ordinary skill in the art upon viewing this disclosure.

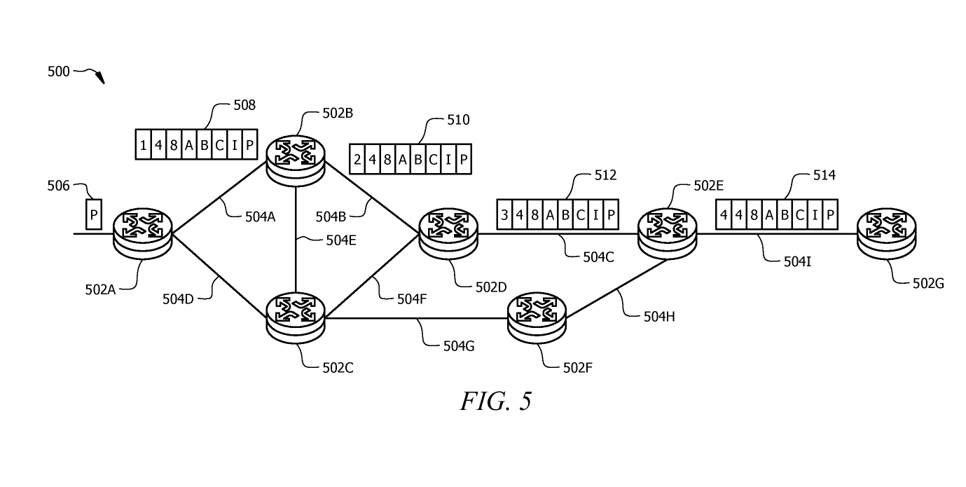

FIG. 5 is a schematic diagram of an embodiment of a network 500 communicating a source routed data packet. Network 500 may comprise a plurality of network nodes 502A-502G and a plurality of links 504A-504I. The network nodes 502A-502G may be configured similar to network nodes 102A-102G and the links 404A-404I may be configured similar to links 104A-104I described in FIG. 1. Network 500 may be configured to communicate data traffic (e.g., data packets) in a flow direction from network node 502A to network node 502G. Network node 502A may be configured to obtain (e.g., to receive or to generate) a data packet 506, to generate a data packet 508, and to send data packet 508 according to the path routing portion of data packet 508. Data packet 508 may be a source routed data packet (e.g., source routed data packet 300 described in FIG. 3). Network node 502A may be configured to encapsulate and/or to add a plurality of fields (e.g., a path routing portion 320 described in FIG. 3) to data packet 506 to generate data packet 508. Data packet 508 may comprise a header portion that comprises a next-hop index field with a value of one, a hop count field with a value of four, and a hop size field with a value of eight. The path routing portion of data packet 508 may indicate a forwarding route along link 504A, link 504B, link 504C, and link 504I. The payload portion of data packet 508 may comprise the payload portion of data packet 506. Network node 502A may be configured to send data packet 508 according to the next-hop index value and the path routing portion of data packet 508. The next-hop index value may reference a first entry in the path routing portion which may indicate to send data packet 508 along link 504A to network node 502B. The next-hop index value may not be incremented and may be sent to the next-hop.

Network node 502B may be configured to receive data packet 508, to validate the packet forwarding of data packet 508, to generate data packet 510, and to send data packet 510 according to the path routing portion of data packet 510. Network node 502B may be configured to examine the data packet 508 to validate the packet forwarding. Network node 502B may be configured to determine a previous-hop network node by using the next-hop index field value of the data packet 508 to locate an entry for the previous-hop network node in the path routing portion of data packet 508. For example, the next-hop index value of one may reference the first entry in the path routing portion of the data packet 508 which may be used to identify a previous-hop network node or a transmitter node. The entry in the path routing portion of the data packet 508 may reference a network node, a port, and/or a link. For example, the first entry in the path routing portion of the data packet 508 may indicate link 504A which may be associated with network node 502A as a previous-hop network node or a transmitter network node on link 504A. Network node 502B may be configured to compare the previous-hop network node indicated by the path routing portion of data packet 508 with the transmitter network node of the data packet 508 (e.g., an actual previous-hop network node). For example, network node 502B may determine the transmitter network node of the data packet 508 by examining an incoming interface (e.g., a link and/or port) where the data packet 508 was received and determining a transmitter associated or connected to the incoming interface. Network node 502B may be configured to discard the data packet 508 and/or to indicate an error has occurred when there is a mismatch between the previous-hop network node indicated by the path routing portion of data packet 508 and the transmitter network node of the data packet 508. When there is not a mismatch between the previous-hop network node indicated by the path routing portion of data packet 508 and the transmitter network node of the data packet 508, network node 502B may be configured to further process data packet 508. Network node 502B may be configured to compare the next-hop index value (e.g., the next-hop value of one) and the hop count value (e.g., the hop count value of four) of data packet 508 to determine if network node 502B is the destination node for the payload. When the next-hop index value is less than the hop count value, network node 502B may be configured to determine that network node 502B is not the destination node for the payload. Network node 502B may increment the next-hop index value of data packet 508 and may use the incremented next-hop index value (e.g., an incremented next-hop index value of two) as the next-hop index value in data packet 510. Network node 502B may be configured to send data packet 510 according to the incremented next-hop index value and the path routing portion of data packet 510. The next-hop index value may reference a second entry in the path routing portion which may indicate to send data packet 510 along link 504B to network node 502D.

Network node 502D may be configured to receive data packet 510, to validate the packet forwarding of data packet 510, to generate data packet 512, and to send data packet 512 according to the path routing portion of data packet 512 similar to as previously described. Network node 502D may be configured to examine the data packet 510 to validate the packet forwarding. Network node 502D may be configured to determine a previous-hop network node by using the next-hop index value of data packet 510 to locate an entry for the previous-hop network node in the path routing portion of data packet 510. Network node 502D may be configured to compare the previous-hop network node indicated by the path routing portion of data packet 510 with the transmitter network node of the data packet 510. Network node 502D may be configured to discard the data packet 510 and/or to indicate an error has occurred when there is a mismatch between the previous-hop network node indicated by the path routing portion of data packet 510 and the transmitter network node of the data packet 510. When there is not a mismatch between the previous-hop network node indicated by the path routing portion of data packet 510 and the transmitter network node of the data packet 510, network node 502D may be configured to further process data packet 510. Network node 502D may be configured to compare the next-hop index value and the hop count value of data packet 510 to determine if network node 502D is the destination node for the payload. When the next-hop index value is less than the hop count field value, network node 502D may be configured to determine that network node 502D is not the destination node for the payload. Network node 502D may increment the next-hop index value of data packet 510 and may use the incremented next-hop index value (e.g., an incremented next-hop index value of three) as the next-hop index value in data packet 512. Network node 502D may be configured to send data packet 512 according to the incremented next-hop index value and the path routing portion of data packet 510. The next-hop index value of data packet 510 may reference a third entry in the path routing portion which may indicate to send data packet 512 along link 504C to network node 502E.

Network node 502E may be configured to receive data packet 512, to validate the packet forwarding of data packet 512, to generate data packet 514, and to send data packet 514 according to the path routing portion of data packet 514 similar to as previously described. Network node 502E may be configured to examine the data packet 512 to validate the packet forwarding. Network node 502E may be configured to determine a previous-hop network node by using the next-hop index value of data packet 512 to locate an entry for the previous-hop network node in the path routing portion of data packet 512. Network node 502E may be configured to compare the previous-hop network node indicated by the path routing portion of data packet 512 with the transmitter network node of the data packet 512. Network node 502E may be configured to discard the data packet 512 and/or to indicate an error has occurred when there is a mismatch between the previous-hop network node indicated by the path routing portion of data packet 512 and the transmitter network node of the data packet 512. When there is not a mismatch between the previous-hop network node indicated by the path routing portion of data packet 512 and the transmitter network node of the data packet 512, network node 502E may be configured to further process data packet 512. Network node 502E may be configured to compare the next-hop index value and the hop count value of data packet 512 to determine if network node 502E is the destination node for the payload. When the next-hop index value is less than the hop count value, network node 502E may be configured to determine that network node 502E is not the destination node for the payload. Network node 502E may increment the next-hop index value of data packet 512 and may use the incremented next-hop index value (e.g., an incremented next-hop index value of four) as the next-hop index value in data packet 514. Network node 502E may be configured to send data packet 514 according to the incremented next-hop index value and the path routing portion of data packet 512. The next-hop index value of data packet 510 may reference a fourth entry in the path routing portion which may indicate to send data packet 514 along link 504I to network node 502G. Network node 502G may be configured to receive data packet 514, to validate the packet forwarding of data packet 514, to unencapsulate data packet 514, and to process the payload. Network node 502G may be configured to examine the data packet 514 to validate the packet forwarding. Network node 502G may be configured to determine a previous-hop network node by using the next-hop index value of data packet 514 to locate an entry for the previous-hop network node in the path routing portion of data packet 514. Network node 502G may be configured to compare the previous-hop network node indicated by the path routing portion of data packet 514 with the transmitter network node of the data packet 514. Network node 502G may be configured to discard the data packet 514 and/or to indicate an error has occurred when there is a mismatch between the previous-hop network node indicated by the path routing portion of data packet 514 and the transmitter network node of the data packet 514. When there is not a mismatch between the previous-hop network node indicated by the path routing portion of data packet 514 and the transmitter network node of the data packet 514, network node 502G may be configured to further process data packet 514. Network node 502G may be configured to compare the next-hop index value and the hop count value of data packet 514 to determine if network node 502G is the destination node for the payload. When the next-hop index value is about equal to the hop count value, network node 502G may be configured to determine that network node 502G is the destination node for the payload. Network node 502G may be configured to process data packet 514. Processing the data packet 514 may comprise unencapsulating and/or removing a plurality of fields (e.g., the path routing portion) from the data packet 514 and processing the payload. The payload portion of data packet 514 may be substantially similar to the payload portion of data packet 506. Processing the payload portion may comprise using the payload, storing the payload into a memory, forwarding the payload, routing (e.g., IP routing) the payload, and/or any other suitable processes as would be appreciated by one of ordinary skill in the art upon viewing this disclosure.

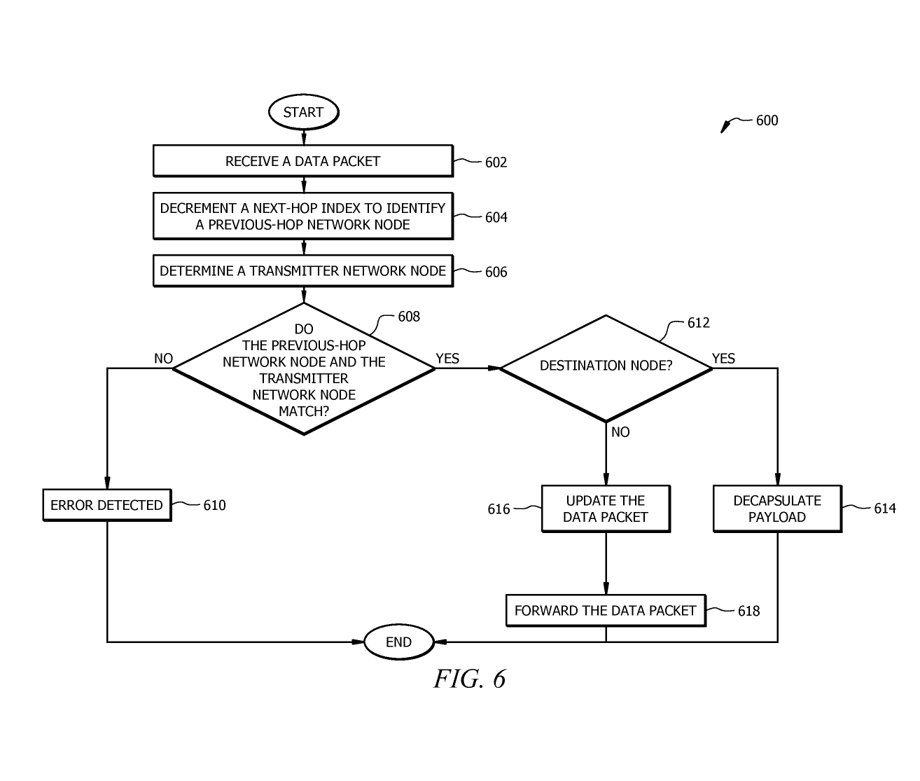

FIG. 6 is a flowchart of an embodiment of a packet forwarding validation method 600 for a network node and may be similar to path validation module 260 described in FIG. 2. In an embodiment, a network node (e.g., network nodes 402A-402G described in FIG. 4) may be configured to receive a data packet, to validate the packet forwarding, to send the data packet, and/or to determine a packet forwarding error has occurred. The network node may be configured to examine a data packet's actual previous next-hop (e.g., a transmitter network node) against a next-hop entry in a path routing portion of the data packet to determine if a packet forwarding error has occurred and/or to identify a point of failure in the network.

At step 602, a network node may receive a data packet. The data packet may comprise a header portion, a path routing portion, and a payload and may be configured similar to the source routed data packet 300 described in FIG. 3. At step 604, the network node may identify a previous-hop network node using the next-hop index. In an embodiment, the next-hop index value of the data packet may be decremented and may be used to locate an entry for the previous-hop network node in the path routing portion of the data packet. For example, the network node may use the decremented next-hop index and the hop size value to parse and/or to traverse through the path routing portion of the data packet. At step 606, the network node may determine the transmitter network node of the data packet. The network node may use an incoming interface (e.g., a port) where the data packet was received to determine the actual previous-hop or transmitter of the data packet. For instance, the network node may use an incoming interface identifier (ID) with a local database (e.g., an SDN controller database) to determine the actual previous-hop and/or the transmitting interface ID. The local database may be distributed by a centralized controller (e.g., an SDN controller), provisioned by an operator, established using a link layer discovery protocol (LLDP), and/or established using any other suitable protocol as would be appreciated by one of ordinary skill in the art upon viewing this disclosure.

At step 608, the network node may compare the previous-hop indicated by the next-hop index and the transmitter network node. When the previous-hop network node indicated by the next-hop index and the transmitter network node match, the network node may proceed to step 612; otherwise, the network node may proceed to step 610. At step 612, the network node may determine if the network node itself is the destination for the payload. When the network node is the destination node for the payload, the network node may proceed to step 614; otherwise, the network node may proceed to step 616. For example, the network node may compare the next-hop index value with the hop count value to determine if the network node is the destination for the payload. When the next-hop index value is greater than the hop count value, the network node may be the destination for the payload. When the next-hop index value is less than or about equal to the hop count value, the network node may not be the destination for the payload. At step 616, the network node may update the data packet. The network node may use the original next-hop index value (e.g., the non-decremented next-hop index value) to determine the next hop for the data packet. The original next-hop index value may be incremented upon determining the next hop for the data packet. At step 618, the network node may send the data packet to the next-hop network node determined in step 616 as indicated by the path routing portion of the data packet and may terminate.

Returning to step 612, when the network node is the destination for the payload, the network node may proceed to step 614. At step 614, the network node may unencapsulate the payload of the data packet. For example, the network node may remove one or more fields (e.g., the path routing portion) of the data packet from the payload. Additionally, the payload portion may be further processed as described in FIG. 4.

Returning to step 608, when the previous-hop network node indicated by the next-hop index and the transmitter network node do not match, the network node may proceed to step 610. At step 610, the network node may indicate an error has occurred. When an error is detected, the network node may identify the transmitter network node as a point of network failure. The network node may also trigger an alarm or an event, set a flag, notify a network operator, invoke a network repair or restoration protocol, and/or any other suitable action as would be appreciated by one of ordinary skill in the art upon viewing this disclosure.

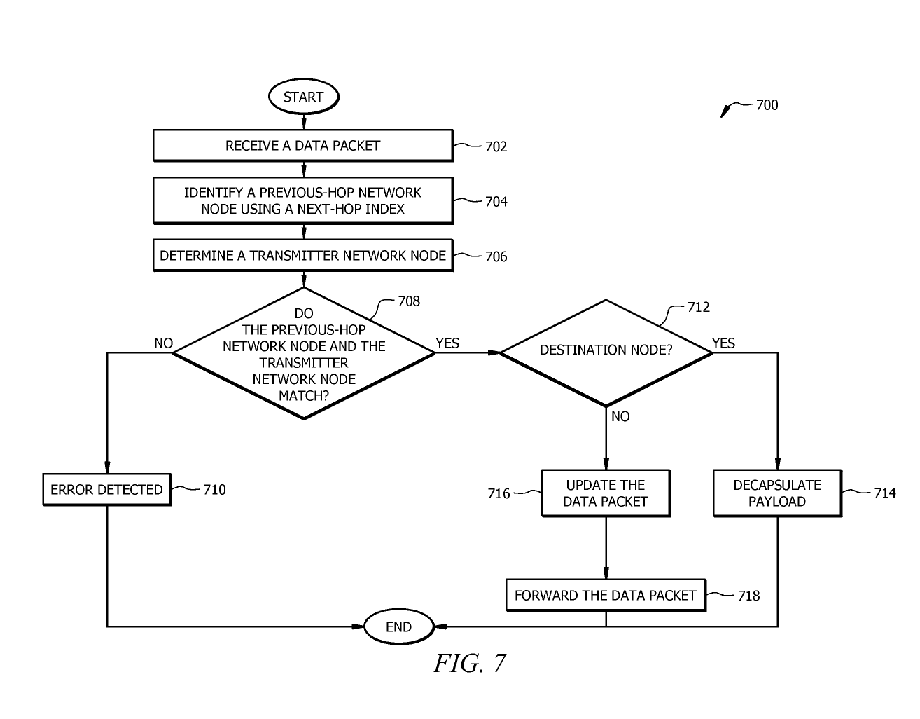

FIG. 7 is a flowchart of another embodiment of a packet forwarding validation method 700 for a network node and may be similar to path validation module 260 described in FIG. 2. In an embodiment, a network node (e.g., network nodes 502A-502G described in FIG. 5) may be configured to receive a data packet, to validate the packet forwarding, to send the data packet, and/or to determine a packet forwarding error has occurred. The network node may be configured to examine a data packet's actual previous next-hop (e.g., a transmitter network node) against a next-hop entry in a path routing portion of the data packet to determine if a packet forwarding error has occurred and/or to identify a point of failure in the network.

At step 702, a network node may receive a data packet. The data packet may comprise a header portion, a path routing portion, and a payload and may be configured similar to the source routed data packet 300 described in FIG. 3. At step 704, the network node may identify a previous-hop network node using the next-hop index. In an embodiment, the next-hop index value of the data packet may be used to locate an entry for the previous-hop network node in the path routing portion of the data packet. For example, the network node may use the next-hop index and the hop size value to parse and/or to traverse through the path routing portion of the data packet. At step 706, the network node may determine the transmitter network node of the data packet. The network node may use an incoming interface (e.g., a port) where the data packet was received to determine the actual previous-hop or transmitter of the data packet. For instance, the network node may use an incoming interface ID with a local database (e.g., an SDN controller database) to determine the actual previous-hop and/or the transmitting interface ID. The local database may be distributed by a centralized controller (e.g., an SDN controller), provisioned by an operator, established using an LLDP, and/or established using any other suitable protocol as would be appreciated by one of ordinary skill in the art upon viewing this disclosure.

At step 708, the network node may compare the previous-hop indicated by the next-hop index and the transmitter network node. When the previous-hop network node indicated by the next-hop index and the transmitter network node match, the network node may proceed to step 712; otherwise, the network node may proceed to step 710. At step 712, the network node may determine if the network node is the destination for the payload. When the network node is the destination node for the payload, the network node may proceed to step 714; otherwise, the network node may proceed to step 716. For example, the network node may compare the next-hop index value with the hop count value to determine if the network node is the destination for the payload. When the next-hop index value is about equal to the hop count value, the network node may be the destination for the payload. When the next-hop index value is less than the hop count value, the network node may not be the destination for the payload. At step 716, the network node may update the data packet. The network node may increment the next-hop index value and may use the incremented next-hop index value to determine the next hop for the data packet. At step 718, the network node may send the data packet to the next-hop network node determined in step 716 as indicated by the path routing portion of the data packet and may terminate.

Returning to step 712, when the network node is the destination for the payload, the network node may proceed to step 714. At step 714, the network node may unencapsulate the payload of the data packet. For example, the network node may remove one or more fields (e.g., the path routing portion) of the data packet from the payload. Additionally, the payload portion may be further processed as described in FIG. 5.

Returning to step 708, when the previous-hop network node indicated by the next-hop index and the transmitter network node do not match, the network node may proceed to step 710. At step 710, the network node may indicate an error has occurred. When an error is detected, the network node may identify the transmitter network node as a point of network failure. The network node may also trigger an alarm or an event, set a flag, notify a network operator, invoke a network repair or restoration protocol, and/or any other suitable action as would be appreciated by one of ordinary skill in the art upon viewing this disclosure.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, e.g., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. The use of the term “about” means ±10% of the subsequent number, unless otherwise stated. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed:

1. A packet forwarding validation method comprising:
receiving a data packet that comprises a next-hop index and a plurality of next-hop identifiers, wherein the next-hop index references a next-hop identifier from the plurality of next-hop identifiers, and wherein the plurality of next-hop identifiers indicates a sequence of next-hops through a network for the data packet;
identifying a previous-hop network node using the next-hop index and the plurality of next-hop identifiers;
determining a transmitter network node of the data packet;
comparing the previous-hop network node and the transmitter network node;
detecting a forwarding error when the previous-hop network node and the transmitter network node are not the same; and
processing the data packet when the previous-hop network node and the transmitter network node are the same.

2. The method of claim 1, wherein determining the transmitter network node comprises using an incoming interface that received the data packet, and wherein the incoming interface comprises at least one of a link or a port.

3. The method of claim 1, wherein the data packet comprises a payload, and wherein processing the data packet comprises:
determining whether the data packet has reached a destination for a payload using the next-hop index and a hop count field within the data packet, wherein the data packet has reached the destination for the payload when the next-hop index equals the hop count field, and wherein the data packet has not reached the destination for the payload when the next-hop index is less than the hop count field.

4. The method of claim 3, wherein when the data packet has not reached the destination for the payload, processing the data packet further comprises:
incrementing the next-hop index;
determining a next-hop network node using the incremented next-hop index and the plurality of next-hop identifiers; and
forwarding the data packet using the incremented next-hop index.

5. The method of claim 3, wherein when the data packet has reached the destination for the payload, processing the data packet further comprises removing the next-hop index, the plurality of next-hop indexes, and the hop count field from the data packet.

6. The method of claim 1, wherein the data packet comprises a payload, and wherein
identifying the previous-hop network node comprises:
determining a next-hop index value, wherein the next-hop index value is equal to the current value of the next-hop index;
decrementing the next-hop index value; and
identifying the previous-hop network node using the decremented next-hop index value and the plurality of next-hop identifiers.

7. The method of claim 6, wherein processing the data packet comprises:
determining whether the data packet has reached a destination for a payload using the next-hop index and a hop count field within the data packet, wherein the data packet has reached the destination for the payload when the next-hop index is greater than the hop count field, and wherein the data packet has not reached the destination for the payload when the next-hop index is not greater than the hop count field.

8. The method of claim 7, wherein when the data packet has not reached the destination for the payload, processing the data packet further comprises:
determining a next-hop network node using the next-hop index and the plurality of next-hop identifiers;
incrementing the next-hop index; and
forwarding the data packet to the next-hop network node.

9. The method of claim 7, wherein when the data packet has reached the destination for the payload, processing the data packet further comprises removing the next-hop index, the plurality of next-hop indexes, and the hop count field from the data packet.

10. An apparatus comprising:
a receiver configured to receive a data packet that comprises:
a next-hop index, wherein the next-hop index indicates a next-hop entry from a plurality of next-hop identifiers;
the plurality of next-hop identifiers, wherein the plurality of next-hop identifiers identifies a sequence of next-hop network nodes for the data packet; and
a payload; and
a processor coupled to a memory and the receiver, wherein the memory comprises computer executable instructions stored in a non-transitory computer readable medium such that when executed by the processor causes the processor to:
identify a previous-hop network node using the next-hop index;
determine a transmitter network node for the data packet;
compare the previous-hop network node and the transmitter network node;
indicate a forwarding error when the previous-hop network node and the transmitter network node do not match; and
forward the data packet when the previous-hop network node and the transmitter network node match.

11. The apparatus of claim 10, wherein forwarding the data packet comprises:
determining that the apparatus is not a destination for the payload;
incrementing the next-hop index;
determining a next-hop network node using the incremented next-hop index and the plurality of next-hop identifiers; and
sending the data packet to the next-hop network node.

12. The apparatus of claim 10, wherein forwarding the data packet comprises:
determining the apparatus is a destination for the payload; and
unencapsulating the payload.

13. The apparatus of claim 10, wherein identifying the previous-hop network node comprises:
determining a next-hop index value, wherein the next-hop index value is equal to the current value of the next-hop index;
decrementing the next-hop index value; and
identifying the previous-hop network node using the decremented next-hop index value and the plurality of next-hop identifiers.

14. The apparatus of claim 13, wherein forwarding the data packet comprises:
determining that the apparatus is not a destination for the payload;
identifying a next-hop network node using the next-hop index and the plurality of next-hop identifiers;
incrementing the next-hop index; and
sending the data packet that comprises the incremented next-hop index to the next-hop network node.

15. The apparatus of claim 13, wherein forwarding the data packet comprises:
determining the apparatus is a destination for the payload; and
unencapsulating the payload.

16. A computer program product comprising executable instructions stored on a non-transitory computer readable medium, such that, when executed by a processor, causes a network node to:
receive a data packet that comprises:
a next-hop index, wherein the next-hop index indicates a next-hop entry from a plurality of next-hop identifiers;
the plurality of next-hop identifiers, wherein the plurality of next-hop identifiers identifies a sequence of next-hop network nodes for the data packet; and
a payload;
determine a previous-hop network node using the next-hop index;
identify a transmitter network node for the data packet;
compare the previous-hop network node and the transmitter network node;
indicate a forwarding error when the previous-hop network node and the transmitter network node do not match; and
forward the data packet when the previous-hop network node and the transmitter network node match.

17. The computer program product of claim 16, wherein the executable instructions further cause the network node to determine whether the data packet has reached a destination for the payload using the next-hop index and a hop count field within the data packet, wherein the data packet has reached the destination for the payload when the next-hop index equals the hop count field, and wherein the data packet has not reached the destination for the payload when the next-hop index is less than the hop count field.

18. The computer program product of claim 16, wherein forwarding the data packet comprises:
increment the next-hop index;
determine a next-hop network node using the incremented next-hop index and the plurality of next-hop identifiers; and
send the data packet to the next-hop network node using the incremented next-hop index.

19. The computer program product of claim 16, wherein the executable instructions, when executed by the processor, causes the network node to:
determine a next-hop index value, wherein the next-hop index value is equal to the current value of the next-hop index;
decrement the next-hop index value; and
identify the previous-hop network node using the decremented next-hop index value and the plurality of next-hop identifiers.

20. The computer program product of claim 19, wherein the executable instructions, when executed by the processor, causes the network node to:
determine a next-hop network node using the next-hop index and the plurality of next-hop identifiers;
increment the next-hop index; and
forward the data packet that comprises the incremented next-hop index to the next-hop network node.
